(19) United States
(12) Patent Application Publication
(10) Pub. No.: US 2004/0172249 A1
(43) Pub. Date: Sep. 2, 2004

(54) Speech synthesis

(76) Inventors: Paul Alexander Taylor, Edinburgh (GB); Matthew Peter Aylett, Edinburgh (GB); Justin Wynford Andrew Fackrell, Edinburgh (GB)

Correspondence Address: DRINKER BIDDLE & REATH, ONE LOGAN SQUARE, 18TH AND CHERRY STREETS, PHILADELPHIA, PA, 19103-6996, US

(21) Appl. No.: 10/478,348

(22) PCT Filed: May 24, 2002
(86) PCT No.: PCT/GB02/02433

(30) Foreign Application Priority Data
May 25, 2001 (GB) 0112749.7

(51) Int. Cl. G10L 13/08

(52) U.S. Cl. 704/260

(57) ABSTRACT

The invention makes use of a database of diphones derived from natural speech. A text is rendered as a series of target diphones and for each of these a number of predetermined diphone features are identified. Potential matches from the database are identified and a target cost for each of these features is established. The target costs are modified before selecting a least-cost combination. The modification of the target costs may be done by weighting, or by use of distribution functions. The calculation of the least-cost combination may be performed by a dynamic search program such as a Viterbi search. In the preferred embodiments, diphone join costs are also included in the least-cost calculation, and are also modified before the calculation is made. In addition to, or instead of, modification of target costs, the potential matches may be pre-pruned to identify a predetermined number of potential matches in descending order of suitability.

This invention relates to speech synthesis in which synthetic speech is produced from a text using a large database containing fragments of real speech.

Systems of this type are known. In particular, it is known to make use of a large database of diphones, a diphone being a unit of speech extending from the middle of one phoneme to the middle of the next. Since there are approximately forty phonemes in most varieties of English, the number of possible diphones is large. In addition, to construct natural-sounding speech, each diphone may occur in a number of versions having different prosodic qualities such as length and stress, and different acoustic properties such as pitch and amplitude. The required database is thus extremely large, and it is necessary to provide methods of selecting and combining the optimum combination of diphones which can be implemented in code so that the code runs rapidly, and with economical use of computing power. It is known to make use of cost functions in carrying out this process. See for example WO00/30069. However, the quality of output speech provided by known systems requires further improvement.

An object of the present invention is therefore to provide an improved method and apparatus for speech synthesis.

Accordingly, the present invention provides a method of producing synthesised speech from a text, comprising:

(a) providing a database of diphones derived from samples of natural speech;

(b) analysing the text to render the text as a succession of target diphones;

(c) identifying, for each target diphone, the value of each of a number of predetermined diphone features;

(d) identifying in the database diphones which are potential matches to each target diphone;

(e) establishing a target cost for each of said predetermined features of each potential database diphone in relation to each target diphone;

(f) modifying the target cost of each feature in accordance with predetermined factors associated with said diphone features; and

(g) calculating the least-cost combination to achieve output speech corresponding to the text.

The method will typically also include evaluating the join cost of joining each diphone to its successor, and including the join costs in the least-cost calculation. Preferably the join costs are also modified in accordance with predetermined features of one or both of the target diphone and candidate diphone.

The modification of diphone feature costs and join costs may suitably be effected using a simple weighting procedure, but preferably makes use of distribution functions.

In one form, the cost is modified according to a cost function which is V-shaped, and the zero-cost point is located using the centroid of a pre-established probability distribution optionally, the slope of the V may be modified in dependence on the variance of the probability distribution.

In another form, the cost is modified according to a cost function which is the inverse of a pre-established probability distribution.

The calculation of the least-cost combination is suitably performed by a dynamic search program, for example a Viterbi search.

The dynamic search program may be preceded by a step of pre-pruning candidate diphones on the basis of categorical features, preferably by means of a decision tree working on predetermined categorical features of the candidate diphones.

Said diphone features may be one or more of phonetic, prosodic, linguistic, and acoustic features; for example:

word

syllable

adjacent word pair

stress

duration

pitch

intonation contour

position in sentence

text type (e.g. question/statement)

text subject matter

From another aspect, the present invention provides a method of producing synthesised speech from a text, comprising:

(a) providing a database of diphones derived from samples of natural speech;

(b) analysing the text to render the text as a succession of target diphones;

(c) identifying, for each target diphone, the value of each of a number of predetermined diphone features;

(d) identifying in the database diphones which are potential matches to each target diphone;

(e) pre-pruning said potential matches by means of sorting by category to identify a predetermined number of potential matches of descending order of suitability;

(f) establishing a target cost for each of said predetermined features of each potential database diphone in relation to each target diphone; and

(g) calculating the least-cost combination to achieve output speech corresponding to the text.

Said pre-pruning is preferably effected by means of a decision tree.

The invention in other aspects further provides a system for producing synthesised speech from text, as defined in claim 19 or claim 20, and a data carrier for use with such systems, as defined in claim 21.

Embodiments of the invention will now be described, by way of example only, with reference to the drawings, in which:

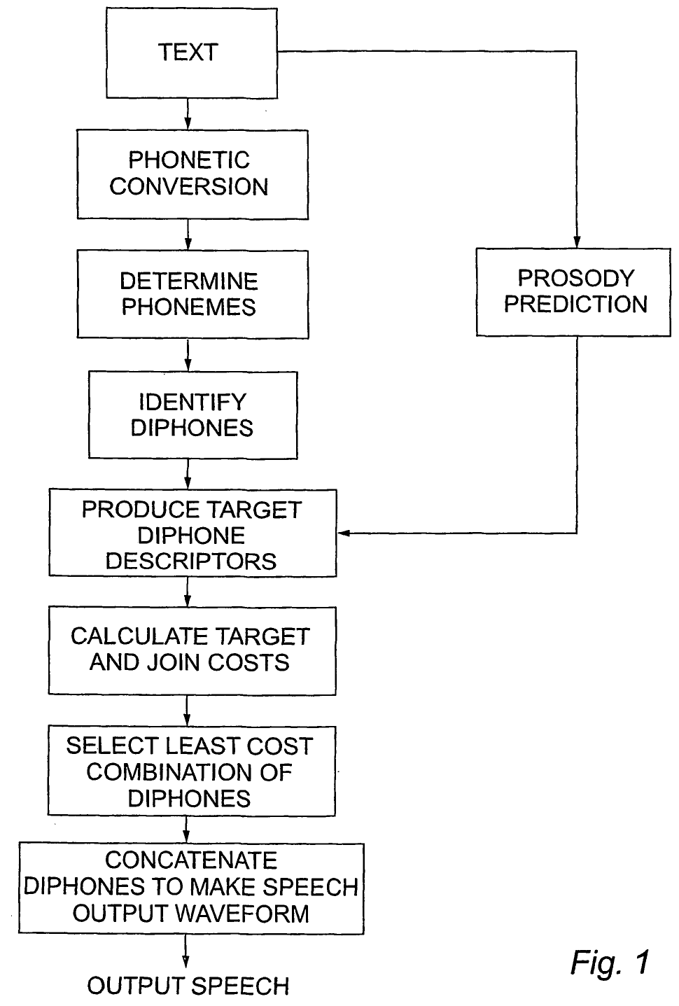

FIG. 1 is a schematic overview of a speech synthesis method in which the invention may be embodied;

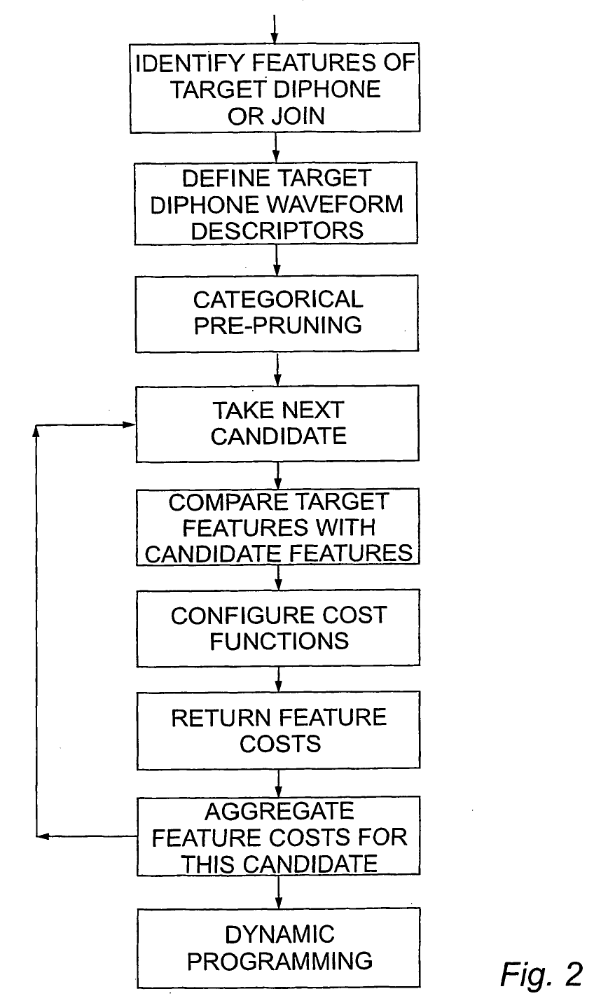

FIG. 2 is a block diagram showing one form of the present invention applied as part of the method of FIG. 1;

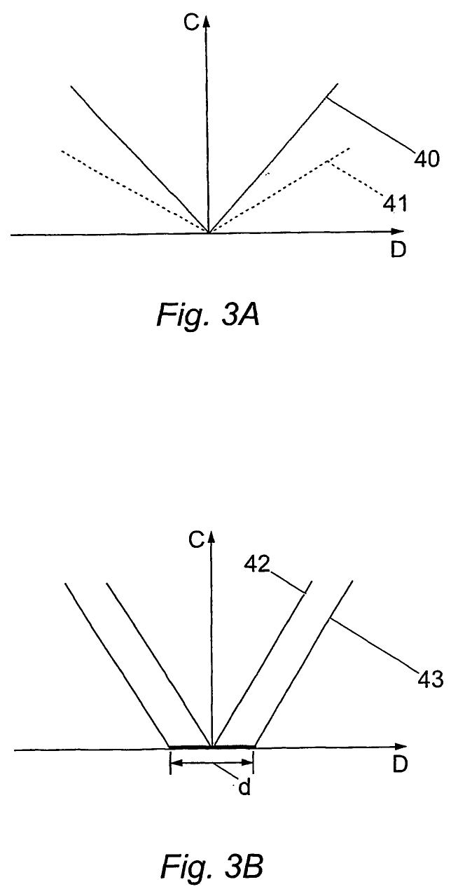

FIG. 3a illustrates one form of cost function configuration used in the example of FIG. 2;

FIG. 3b illustrates an alternative cost function configuration;

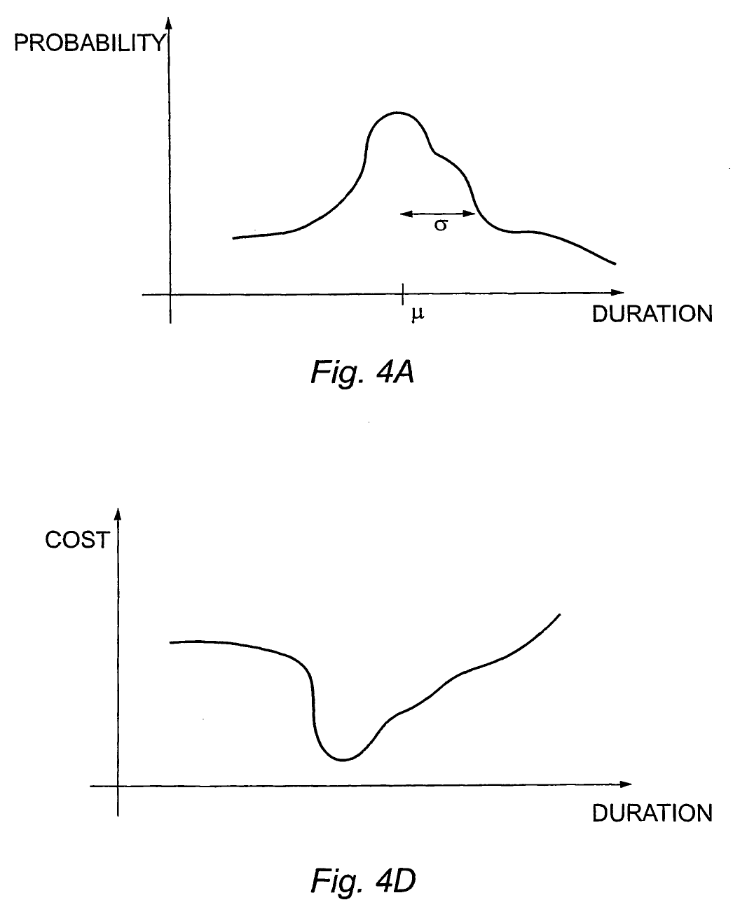

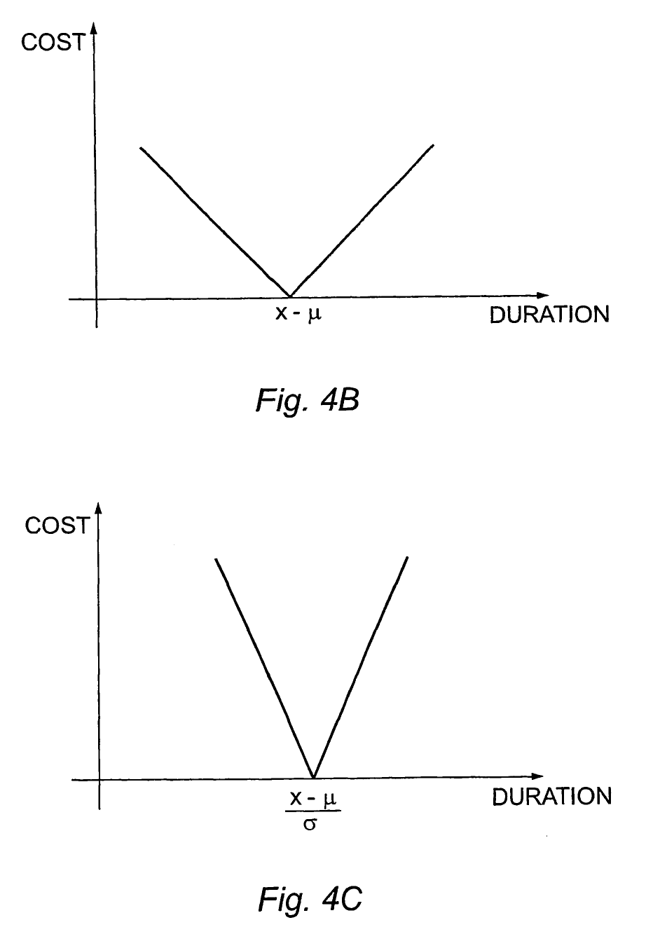

FIG. 4a shows an example of a probability distribution;

FIGS. 4b-4d illustrate other and more generalised forms of cost function configuration; and

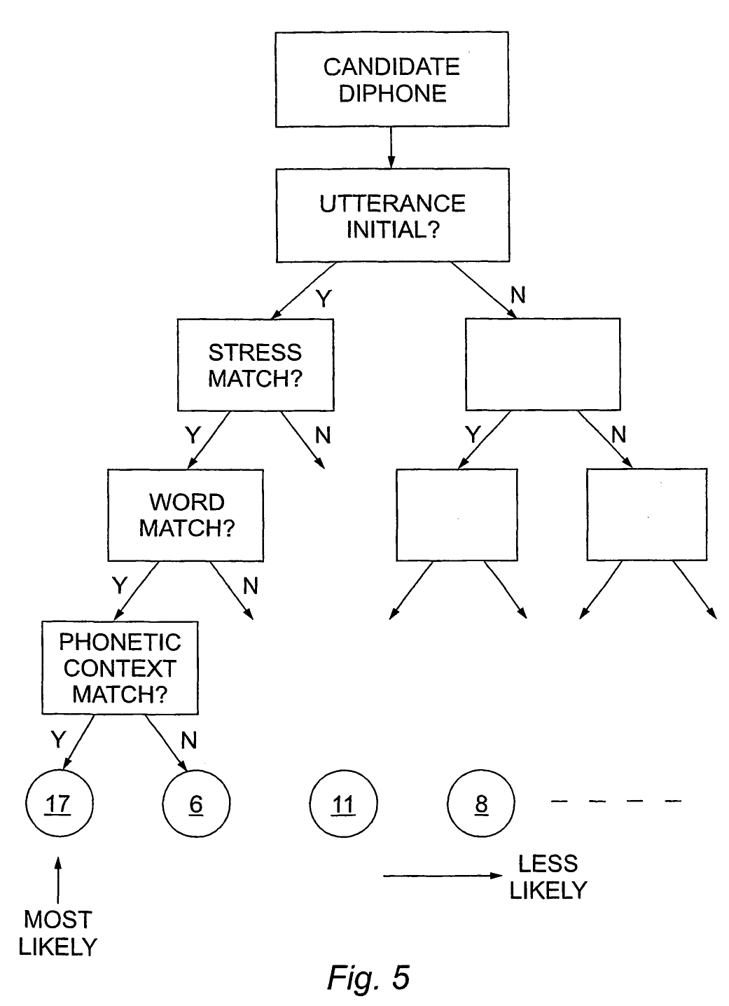

FIG. 5 shows a decision tree which may be used in an optional step of FIG. 2.

Referring to FIG. 1, an input text is provided. This may be an existing text from, for example, a printed book, or may be a one-off text such as a text generated by a computer in response to an enquiry.

The text is then analysed phonetically and prosodically. Specifically, the text is converted into phonetic form, and then divided into phonemes. At the same time, a prosodic analysis produces a prosody prediction for features such as rising/falling tone, pitch and stress. The succession of phonemes together with the prosody prediction is then used to form a succession of diphone descriptors for the desired, or target, diphones.

Such phonetic and prosodic analysis is well known in the art and will not be further described.

The analysed features are then compared with similar features of diphones in a database. The database contains a large number of diphones which have been produced by recording, digitising and analysing quantities of natural speech. The values of the features of the diphones are calculated and recorded when the database is built. Most diphones will appear a considerable number of times with different diphone features arising from qualities of phonetic, prosodic, linguistic and acoustic features. Again, such databases are known per se, and will not be further described.

The comparison is effected by comparing each required target diphone with all possible matching diphones in the database and selecting the optimum combination. That is, the target diphone, say diphone d-o, is compared with all diphones d-o in the database. The optimum combination is selected by calculating a target cost for each recorded diphone and each join between potential recorded diphones, and selecting the lowest-cost combination. The target cost will vary according to differences in selected features such as pitch, stress and duration. The selected diphones are then concatenated to produce the desired output speech.

Concatenation is the process of joining together the sequence of diphones which has been chosen by the unit selection process, in a way that the units retain most of their original acoustic characteristics, but that they join together without audible artefacts; i.e. it is a way of smoothing the joins between diphones. If the unit waveforms are simply placed next to each other to make the output speech waveform, there will tend to be audible artefacts (such as clicks) at the boundaries where one diphone joins another. In the concatenation process these discontinuities are smoothed in the region local to the concatenation points. This type of approach is well known in the field of speech synthesis, and the concatenation step herein will therefore not be described in further detail. The process as thus far described is known. The present invention is concerned principally with improving the effectiveness of the target cost calculation and selection.

One example of the handling of target costs in accordance with the present invention is shown in generalised form in FIG. 2.

The first step is to identify in the incoming data phonetic and other features associated with the diphone. The phonetic features may be features within the diphone itself, for example the presence or absence of silence, or of particular kinds of consonants such as dental or plosive; or they may result from the relationship between that diphone and a neighbour, for example whether a consonant is followed by a particular vowel. Prosodic features which are predicted as target diphone descriptors are determined from the syntactic and semantic context. Of these prosodic descriptors, some are linguistic, i.e. they do not have an explicit acoustic representation, such as stress or prominence, and some are acoustic, such as pitch values and durations.

The example of FIG. 2 then has a step of categorical pre-pruning. This is an optional step, and will be further described below with reference to FIG. 5. Briefly, the pre-pruning step may be used to discard the candidate diphones least likely to fit the target diphones before calculating target costs, in order to reduce the computation required.

The next step is to use a given set of features to define the target diphone in terms of waveform descriptors such as amplitude, length and pitch. The features of the target diphone are then compared with the equivalent features of all selected database diphones to derive, for each candidate diphone, a cost value which is an aggregate of cost values for each of the selected features.

Similarly, for each succeeding pair of diphones a join cost is established. This is an aggregation of the differences between physical parameters of the end of one diphone and the beginning of the next.

The cost for each feature has hitherto been established simply by means of a standard cost function applied to the difference in value between the target feature and the candidate feature, with a perfect match returning a cost of zero. Here, however, the cost function is modified or weighted in dependence on properties of the target, such as phonetic context. The process includes configuring the cost function for each feature such that features which are of less significance in the final utterance have a reduced effect on the cost comparison, and vice versa.

In a simple form, the cost function may be a simple weighting. For example, a variance in length might be given its standard value in an unstressed position but be weighted by a factor of 1.5 in a stressed position, and be weighted by a factor of 0.5 if unstressed at the end of a sentence.

In this way, the costs of individual target/database comparisons are modified according to predetermined context-specific rules.

The least-cost path is then determined in a known manner. Our preferred method for this is by a dynamic programming technique as known in the art; see for example ‘Discrete-time Processing of Speech Signals’, J Deller, J Proakis and J Hansen, Macmillan, 1993.

The foregoing example makes use of modifying the cost function by applying a simple weighting. As seen in FIG. 3a, the relationship between a given feature difference D and the resulting cost C is a V-shape function 40. Applying a weighting will produce a modified V-shape function 41.

Other forms of weighting or modification of cost figures may be used. For example in FIG. 3b the standard feature difference/cost function is 42 but a context-determined offset d may be included in a modified function 43, which will have the effect of ignoring variances below a context-determined threshold. This could be combined with alteration of the function slope outside the offset.

On a more generalised view, the weighting applied to a given feature difference may be based on a statistical distribution for that feature. Referring to FIG. 4a, a given numerical diphone feature of a target diphone has a probability density function (pdf) 50. As one example, this shows the pdf for the duration of the phoneme /b/ with left neighbour /a/, right neighbour /c/, stressed, close to end of sentence, plus such other features as may be defined. The pdf 50 has a mean μ and a standard deviation σ. Duration is given as one example only: the same may be applied to any other numerical feature, such as pitch or amplitude.

One very simple way of making use of the pdf is to use the mean μ to define the location of the zero point of the cost function, as seen in FIG. 4b.

FIG. 4c shows a development of the method of FIG. 4b, in which the spread of the pdf a is used to modify the slope of the cost function. This has the effect of modifying the cost function in a manner which is more dependent on an actual distribution derived from real speech.

The foregoing describes methods in which cost function parameters are modified by target diphone descriptors, i.e. the shape and size of the contribution from a cost function can be modified by the target diphone descriptors. All cost functions considered thus far have the following characteristics: they return zero for a perfect match, and return a value not lower than zero for non-perfect matches. Typically the cost functions are V-shaped.

We have described above how the cost function for some numerical feature. X (e.g. pitch frequency or phone duration) in some particular target context described by a set of categorical features Y (e.g. stressed, utterance-initial) is configured using information about the conditional distribution of feature X given categorical features Y. For example, “the distribution of speech frequency for the left demiphone of diphones occurring with the left demiphone ‘a’ and right demiphone ‘b’, with the left demiphone stressed and the right demiphone unstressed, occurring in the first syllable of an utterance, is characterised by having a centroid location value of 100 Hz and a standard deviation of 20 Hz”. Which features are used to determine Y may be determined by rule (by expert) or automatically using, for example, decision trees.

In the foregoing, the parameters which have been used to control the subsequent shape/size of the cost function have been the centroid and variance of the distribution, with the centroid determining the point where the cost function returns a cost of zero, and the variance determining the steepness of the sides of the cost function.

However, this is a somewhat simplistic way to define the distribution, since it tacitly assumes that the distribution is Gaussian. Experience in the speech field suggests that distributions of speech features such as phoneme durations and pitch values are often heavily skewed, and therefore using only centroid and variance may be sub-optimal.

It is instead possible to use the probability distribution itself as the cost function. This is performed simply by inverting the probability distribution so that the most likely value (with high probability) will return the smallest cost, and unlikely values(with low probability) will return high costs. FIG. 4d shows this form of cost function for the pdf of FIG. 4a.

This use of the inversion of the pdf can be regarded as one extreme of how the pdf is parameterised to give the modified cost function. The other extreme is to use only the means or centroid of the pdf. Other parameterisations between these two extremes could be used: for example mean, variance and skew; or the mean and chosen percentiles.

Turning to FIG. 5, a preferred form of the optional step of categorical pre-pruning will now be described.

Categorical pre-pruning is a way of effectively reducing the size of the database partition which has to be searched in order to find N ‘best’ candidates according to target cost. The technique is suboptimal, but in practice the difference in speech quality between a system using categorical pre-pruning and one not using it is minimal, yet the difference in performance is large.

Given a sequence of descriptors of target diphones, the first part of the unit selection search is to give each candidate a target cost. For each target diphone A-B we evaluate the target cost of every diphone A-B occurring in the large database. Since there may be thousands of examples of A-B in the database, this can be time-consuming. Furthermore, it has been observed that the units finally selected (after the Viterbi search) very often have perfect matches on a number of categorical features.

Categorical pre-pruning works as follows. For each target diphone, a tree is set up, as illustrated in FIG. 5, in which each tree node represents a question about a feature match between the candidate and the target. The candidate branches to the left if the answer is YES and to the right if the answer is NO. After dropping every candidate down this tree, there will be some candidates at a number of tree leaves. The ‘best’ candidates, who answered YES YES YES YES, will be at the leftmost leaf, and the worst candidate, who answered NO NO NO NO, will be at the rightmost leaf.

Next we choose some ‘pruning level’ N which is the number of candidates we want to use for each target diphone in the Viterbi search. Starting from the leftmost leaf, we step rightwards, collecting candidates as we go, until we have M candidates, with M being at least N. Next we perform pruning, for example histogram pruning, to remove (M-N) candidates, so that we are left with N candidates to use in the dynamic programming or Viterbi search.

For example, in FIG. 5 the most likely (YES YES YES YES) group has 17 candidates, the next (YES YES YES NO) has six, and the next eleven. If the selected pruning level is 30, these three groups will yield 34 candidates, which can then be reduced to 30 by carrying out a pruning of the third group.

The present invention thus provides improved methods of speech synthesis offering more natural speech quality and/or reduced computational requirements. Modifications of the foregoing embodiments may be made within the scope of the invention.

1. A method of producing synthesised speech from a text, comprising:
(a) providing a database of diphones derived from samples of natural speech;
(b) analysing the text to render the text as a succession of target diphones;
(c) identifying, for each target diphone, the value of each of a number of predetermined diphone features;
(d) identifying in the database diphones which are potential matches to each target diphone;
(e) establishing a target cost for each of said predetermined features of each potential database diphone in relation to each target diphone;
(f) modifying the target cost of each feature in accordance with predetermined factors associated with said diphone features; and
(g) calculating the least-cost combination to achieve output speech corresponding to the text.

2. A method according to claim 1, including evaluating the join cost of joining each diphone to its successor, and including the join costs in the least-cost calculation.

3. A method according to claim 2, in which the join costs are also modified in accordance with predetermined features of one or both of the target diphone and candidate diphone.

4. A method according to claim 3, in which the modification of diphone feature costs and join costs is effected using a simple weighting procedure.

5. A method according to claim 3, in which the modification of diphone feature costs and join costs makes use of distribution functions.

6. A method according to claim 5, in which the cost is modified according to a cost function which is V-shaped, and the zero-cost point is located using the centroid of a pre-established probability distribution.

7. A method according to claim 6, in which the slope of the V is modified in dependence on the variance of the probability distribution.

8. A method according to claim 5, in which the cost is modified according to a cost function which is the inverse of a pre-established probability distribution.

9. A method according to any preceding claim, in which calculation of the least-cost combination is performed by a dynamic search program.

10. A method according to claim 9, in which the dynamic search program is a Viterbi search.

11. A method according to any preceding claim and including the step of pre-pruning candidate diphones on the basis of categorical features.

12. A method according to claim 11, in which the pre-pruning step makes use of a decision tree working on predetermined categorical features of the candidate diphones.

13. A method according to claim 12, in which said diphone features are one or more of phonetic, prosodic, linguistic, and acoustic features.

14. A method according to claim 13, in which said features are one or more of:
word
syllable
adjacent word pair
stress
duration
pitch
intonation contour
position in sentence
text type
text subject matter

15. A method according to any of claims 11 to 14, in which the pre-pruning step assigns values based on suitability to the target diphones, and in which said pre-pruning values are used in assigning target costs.

16. A method of producing synthesised speech from a text, comprising:
(a) providing a database of diphones derived from samples of natural speech;
(b) analysing the text to render the text as a succession of target diphones;
(c) identifying, for each target diphone, the value of each of a number of predetermined diphone features;
(d) identifying in the database diphones which are potential matches to each target diphone;
(e) pre-pruning said potential matches by means of sorting by category to identify a predetermined number of potential matches of descending order of suitability;
(f) establishing a target cost for each of said predetermined features of each potential database diphone in relation to each target diphone; and
(g) calculating the least-cost combination to achieve output speech corresponding to the text.

17. A method according to claim 16, in which said pre-pruning is effected by means of a decision tree.

18. A method according to claim 16 or claim 17, in which said pre-pruning step assigns values based on suitability to the target diphones, and in which said pre-pruning values are used in assigning target costs.

19. A system for producing synthesised speech from text, the system comprising:
memory means storing a database of diphones derived from natural speech;
processing means arranged to:
(a) analyse the text to render the text as a succession of target diphones;
(b) identify, for each target diphone, the value of each of a number of predetermined diphone features;
(c) identify in the database diphones which are potential matches to each target diphone;
(d) establish a target cost for each of said predetermined features of each potential database diphone in relation to each target diphone;
(e) modify the target cost of each feature in accordance with predetermined factors associated with said diphone features; and
(f) calculate the least-cost combination to achieve output speech corresponding to the text; and
speech synthesis means operable to retrieve and concatenate the diphones identified as constituting said least cost combination.

20. A system for producing synthesised speech from text, the system comprising:
memory means storing a database of diphones derived from natural speech;
processing means arranged to:
(a) analyse the text to render the text as a succession of target diphones;
(b) identify, for each target diphone, the value of each of a number of predetermined diphone features;
(c) identify in the database diphones which are potential matches to each target diphone;
(d) pre-prune said potential matches by means of sorting by category to identify a predetermined number of potential matches of descending order of suitability;
(e) establish a target cost for each of said predetermined features of each potential database diphone in relation to each target diphone; and
(f) calculate the least-cost combination to achieve output speech corresponding to the text; and
speech synthesis means operable to retrieve and concatenate the diphones identified as constituting said least cost combination.

21. A data carrier holding software adapted to cause a processing means to operate steps (a)-(f) of claim 19 or claim 20.
